(19) United States
(12) Patent Application Publication
(10) Pub. No.: US 2010/0201867 A1
(43) Pub. Date: Aug. 12, 2010

(54) Method for Graphical Scaling of LCDS in Mobile Television Devices

(76) Inventor: Igor Sinyak, Mountain View, CA (US)

Correspondence Address: Robert D. Shedd, Patent Operations;THOMSON Licensing LLC, P.O. Box 5312, Princeton, NJ, 08543-5312, US

(21) Appl. No.: 11/990,542

(22) PCT Filed: Aug. 22, 2006
(86) PCT No.: PCT/US2006/032941

§ 371 Date: Aug. 25, 2009

Related U.S. Application Data
(60) Provisional application No. 60/710,831, filed on Aug. 24, 2005.

(51) Int. Cl. H04N 7/01

(52) U.S. Cl. 348/448; 348/E07.003

(57) ABSTRACT

A system for graphically scaling of LCDs in mobile television devices is provided. PAL resolution is 720×576, and DVB-T broadcasts in Europe, for example, use this resolution. In order to display this PAL video on a 480×272 LCD, scaling algorithms are used. However, when MHEG-5 content is present on the video stream, a different scaling is required. The present principles provide a mechanism to convert the interlaced PAL video at a resolution of 720—576 to the progressive display of an LCD having a resolution of 480—272.

### BACKGROUND

1 . Field of the Invention

The present invention relates to mobile television or video devices operating on terrestrial broadcast networks. More particularly, it relates to a system to display PAL video with subtitles and/or MHEG5 content on an LCD display of a mobile video device.

2. Description of the Prior Art

Terrestrial television (also known as over-the-air, OTA or broadcast television) was the traditional method of television broadcast signal delivery prior to the advent of cable and satellite television. Although still in wide use, in some countries it is slowly becoming obsolete but in others, digital terrestrial has become popular. It works via radio waves transmitted through open space, usually unencrypted (commonly known as “free-to-air” television).

Terrestrial television broadcasting dates back to the very beginnings of television as a medium itself with the first long-distance public television broadcast from Washington, D.C., on Apr. 7, 1927. Aside from transmission by high-flying planes moving in a loop using a system developed by Westinghouse called Stratovision, there was virtually no other method of television delivery until the 1950s with the advent of cable television, or community antenna television (CATV). The first non-terrestrial method of delivering television signals that in no way depended on a signal originating from a traditional terrestrial source began with the use of communications satellites during the 1960s and 1970s.

In the United States and most of the rest of North America as well, terrestrial television underwent a revolutionary transformation with the eventual acceptance of the NTSC standard for color television broadcasts in 1953. Later, Europe and the rest of the world either chose between the later PAL and SECAM color television standards, or adopted NTSC.

The PAL Standard however, provides a video resolution that is 720×576. Many DVB-T broadcasts in Europe, for example, use this standard, and thus this video resolution. However, in order to display this PAL video on a 480×272 LCD, scaling algorithms are used. However, when Multimedia and Hypermedia information coding Expert Group (MHEG-5) content is present on the video stream, a different scaling of the video is required to display the same on a 480×272 LCD of a mobile video device.

### SUMMARY OF THE INVENTION

The present principles provide a mechanism to convert the interlaced PAL video at a resolution of 720×576 to the progressive display of an LCD of a mobile video device having a resolution of 480×272.

This and other aspects are achieved in accordance with the present principles wherein the method for graphical scaling of LCDs in mobile television devices, includes converting a PAL video from an interlaced video stream to a progressive video stream, determining whether graphics are displayed in addition to the video, performing a first type of scaling on the video stream when no graphics are being displayed in the same, and performing a field reduction of the video stream to finally reduce the same to a resolution compatible with the LCD display of the mobile television device.

A second type of scaling can be performed on the video stream when graphics are displayed in the same. An example of such scaling can be performed by pixel decimation. The first type of scaling can be, for example, utilizing an 8 tap horizontal filter on a predetermined media processor.

In accordance with one implementation of the present principles, the conversion includes capturing a first field out of every frame in the video stream.

According to another implementation of the present principles, the method for graphical scaling of LCDs in mobile television devices, includes converting an interlaced PAL video stream with a resolution of 720×576 to a progressive video stream having a resolution of 720×288, determining whether graphics are displayed in addition to the video, performing a first type of scaling on the progressive video stream when no graphics are being displayed in the same, and performing a field reduction of the progressive video stream to finally reduce the same to a resolution of 480×270 that is compatible with the LCD display of the mobile television device.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a block diagram of the process for graphical display of PAL video on an LCD of a mobile video device according to an implementation of the present principles; and

FIG. 2s is a diagrammatic representation of results of the process of FIG. 1; and

FIG. 2b is a diagrammatic representation of the subtitle scaling according to an aspect of the present principles.

### DETAILED DESCRIPTION

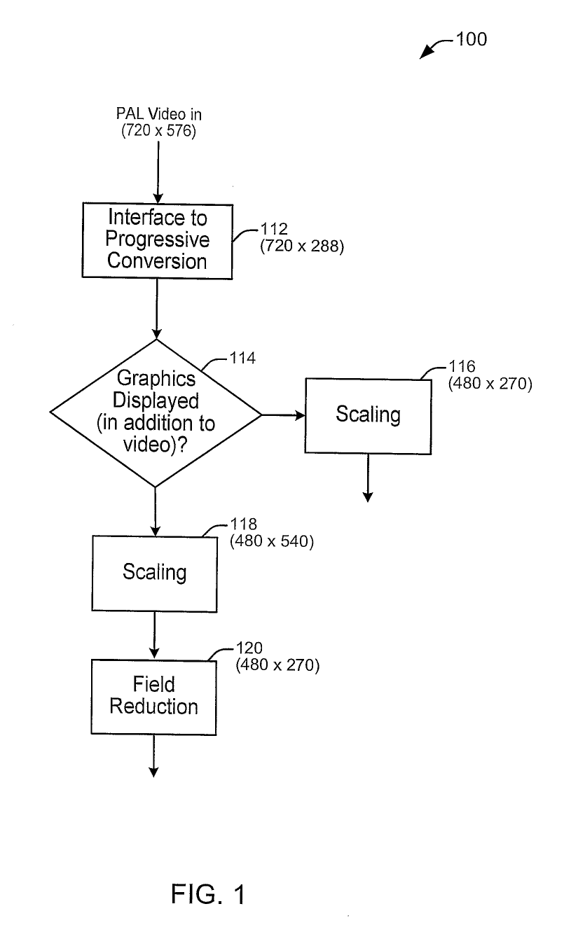

FIG. 1 shows a flow diagram illustrating the scaling operations of the present principles. A PAL video input having a resolution of 720×576 is converted to a progressive signal (112) to produce a progressive resolution of 720×288. The input PAL signal is interlaced, which 50 fields/25 frames. The present conversion is adapted to capture the first field out of every frame, thereby reducing the resolution to the 720×288. One advantage to this approach is the removal of the artifact that occurs as a result of the 2^{nd} field being temporally positioned after the first field. Those of skill in the art will recognize that any suitable device for receiving digital YUV data and outputting RGB data to drive the LCD may be used without departing from the spirit of the present principles. For example, the Epson S1D13719 chip could be used for such application.

Next a determination is made whether graphics are displayed in addition to the video (114). This is done using a Multimedia and Hypermedia information coding Expert Group (MHEG-5) application. If graphics are displayed, additional scaling (116) of the 720×288 signal is performed to provide a resulting image at 480×270. This scaling (116) can be performed using pixel decimation, or any other known technique.

When graphics are not displayed (114), the scaling (118) can be performed to provide a signal output with a resolution of 480×540. By way of example, this scaling is done using an 8-tap horizontal filter on an ST5517 media processor, resulting in a high quality scaled image. Those of skill in the art will recognize that ST5517 media processor can be programmed accordingly using an M/N ratio.

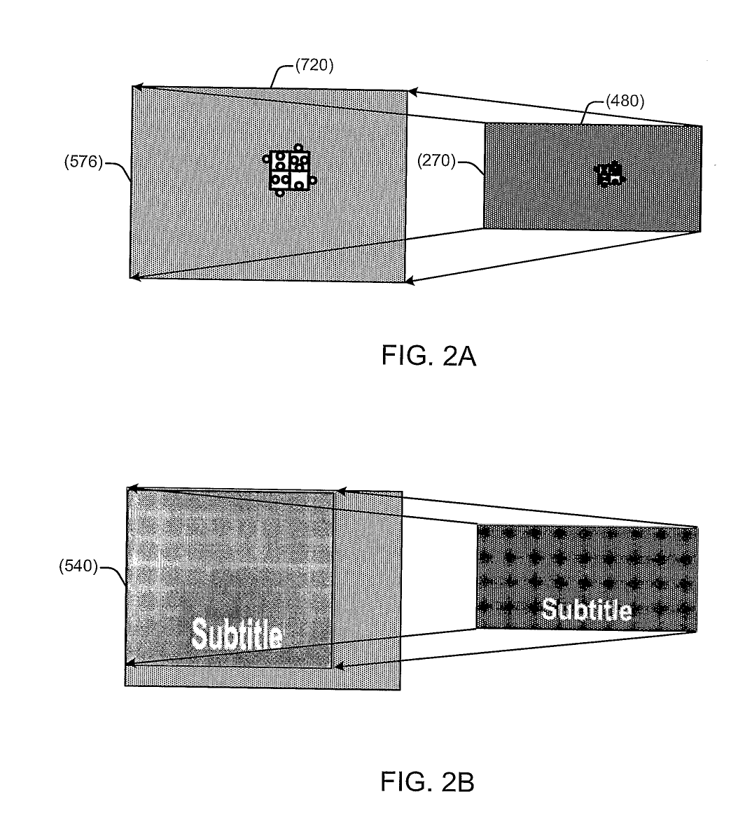

A field reduction process (120), such as that performed in the interlace to progressive conversion 112, is preformed to drop the signal to the predetermined 480×270 scale for display on the LCD screen of the mobile video device. FIG. 2a shows a diagrammatic representation of the final scaling results.

In the exemplary implementation shown, the ST5517 scales the video plane only. Graphics are on the OSD plane, and as such, use the full PAL use the full PAL 720×576 resolution.

Although it is generally preferred to have no graphics being displayed in order to utilize an ST5517 media processing device programmed in accordance with the present principles, there is, however, a special case of such graphics that the present principles can be applied. In particular, subtitle graphics. Since subtitle graphics are updated on the order of only once per second, the ST5517 can be programmed to scale/place them such that they are in the appropriate place for the 480×540 resolution, which will then make them show up in the right place and with the right aspect ration on the LCD display.

FIG. 2b shows the effect of scaling the subtitles in accordance with an aspect of the present principles. The subtitles could be scaled in several possible ways. For example, 1) they do not get scaled and are received as a bitmap. The bitmap could then be repositioned to be in the same relevant position; 2) scale the subtitles with a filter appropriate for raster fonts, such that the subtitles maintain their original size relative to the screen; and 3) a combination of 1 & 2, which would result in a scaling of the subtitles such that they are relatively larger than the original, compared to the size of the display. This scaling method provides the ability to increase the relative size of the subtitles to enhance their readability on the small LCD display.

It is to be understood that the present principles may be implemented in various forms of hardware, software, firmware, special purpose processors, or a combination thereof. Preferably, the present principals are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central

1. A method for graphical scaling of LCDs in mobile television devices, the method comprising the steps of:
converting a PAL video from an interlaced video stream to a progressive video stream;
determining whether graphics are displayed in addition to the video;
performing a first type of scaling on the video stream when no graphics are being displayed in the same; and
performing a field reduction of the video stream to finally reduce the same to a resolution compatible with the LCD display of the mobile television device.

2. The method according to claim 1, further comprising performing a second type of scaling on the video stream when graphics are displayed in the same.

3. The method according to claim 1, wherein said first type of scaling comprises utilizing an 8 tap horizontal filter on a predetermined media processor.

4. The method according to claim 2, wherein said second type of scaling comprises pixel decimation.

5. The method according to claim 1, wherein said converting comprises capturing a first field out of every frame in the video stream.

6. A method for graphical scaling of LCDs in mobile television devices, the method comprising the steps of:
converting an interlaced PAL video stream with a resolution of 720×576 to a progressive video stream having a resolution of 720×288;
determining whether graphics are displayed in addition to the video;
performing a first type of scaling on the progressive video stream when no graphics are being displayed in the same; and
performing a field reduction of the progressive video stream to finally reduce the same to a resolution of 480×270 that is compatible with the LCD display of the mobile television device.

7. The method according to claim 6, further comprising performing a second type of scaling on the video stream when graphics are displayed in the same.

8. The method according to claim 6, wherein said first type of scaling comprises utilizing an 8 tap horizontal filter on a predetermined media processor programmed to perform the graphical scaling.

9. The method according to claim 7, wherein said second type of scaling comprises pixel decimation.

10. The method according to claim 6, wherein said converting comprises capturing a first field out of every frame in the video stream.
